(19) United States
(12) Patent Application Publication
(10) Pub. No.: US 2012/0264044 A1
(43) Pub. Date: Oct. 18, 2012

(54) NEGATIVE-CHARGEABLE ERASABLE ELECTROPHOTOGRAPHIC TONER AND PRODUCTION METHOD THEREOF

(75) Inventors: Hideki IKEDA, Hamura-shi (JP); Hideyoshi Niinuma, Hanno-shi (JP); Toshiaki Kanamura, Ome-shi (JP)

(73) Assignees: CASIO COMPUTER CO., LTD., Tokyo (JP); CASIO ELECTRONICS MANUFACTURING CO., LTD., Iruma-shi (JP)

(21) Appl. No.: 13/445,315

(22) Filed: Apr. 12, 2012

(30) Foreign Application Priority Data
Apr. 13, 2011 (JP) 2011-089329

(51) Int. Cl. G03G 9/087

(52) U.S. Cl. 430/108.11; 430/137.18

(57) ABSTRACT

Disclosed is a negative-chargeable erasable electrophotographic toner including a binder resin, a near infrared absorption dye, a decolorizing agent, a charge controlling agent, and fluororesin particles. The toner is obtained by adding 5 to 20 parts by mass of the fluororesin particles to 100 parts by mass of the binder resin.

### CROSS-REFERENCE TO RELATED APPLICATIONS

This application is based upon and claims the benefit of priority from prior Japanese Patent Application No. 2011-089329, filed Apr. 13, 2011, the entire contents of which are incorporated herein by reference.

### BACKGROUND OF THE INVENTION

1. Field of the Invention

The present invention relates to a negative-chargeable erasable electrophotographic toner having a sufficient negative-chargeable property and a method of producing the same.

2. Description of the Related Art

Conventionally, an erasable toner prepared by using a near infrared absorption dye in place of a pigment has been known. Such an erasable toner is described in JP-A 4-362935 and JP-A 5-119520. These erasable toners have color close to blue under visible light. As a decolorizing agent, a quaternary ammonium boron complex is added to these erasable toners.

If a product printed by the erasable toners is irradiated with near infrared rays from a halogen lamp, a laser or LED, in a state where the product is heated, the infrared absorption dye in the toners becomes an excited state. The dye is reacted with the quaternary ammonium boron complex as the decolorizing agent and the decolorization reaction occurs. Thus, the toners of the printed product are decolorized. The print on the paper which has been printed once is decolorized by such a phenomenon and the paper can be reused.

Currently, a negative-chargeable toner is commonly used for color printers. In contrast, a near-infrared sensitizing dye and a decolorizing agent, which are typically used for erasable toners, have positive-chargeable properties. Thus, there is a problem such that sufficient negative-chargeable properties are not obtained. In order to obtain sufficient negative-chargeable properties, it is contemplated that the amount of the charge controlling agent is increased.

However, if the amount of the charge controlling agent is increased, the decolorization effect in which the near infrared absorption dye is faded and decolorized by the interaction of the dispersed charge controlling agent with the near infrared absorption dye is impaired. Additionally, a sufficient amount of tribocharge is not applied, and thus a function sufficient as an electrophotographic developer is not exhibited, which is disadvantageous.

In order to solve these problems, for example, a method of externally adding a charge controlling agent to toner particles, which is described in JP-A 5-134448, has been proposed. However, the charge controlling agent is detached and/or aggregated, which causes a lack of the fluidity and stability of toner.

### BRIEF SUMMARY OF THE INVENTION

It is an object of the present invention to provide a negative-chargeable erasable electrophotographic toner having a sufficient negative-chargeable property and a method for producing the same.

According to a first aspect of the invention, there is provided a negative-chargeable erasable electrophotographic toner comprising a negative-chargeable binder resin, a near infrared absorption dye, a decolorizing agent, a charge controlling agent, and fluororesin particles.

The negative-chargeable erasable electrophotographic toner is preferably obtained by adding 5 to 20 parts by mass of the fluororesin particles to 100 parts by mass of the binder resin.

Further preferably, the fluororesin particles are selected from the group consisting of a polytetrafluoroethylene (tetra-fluorinated resin [PTFE]), a polychlorotrifluoroethylene (tri-fluorinated resin [PCTFE, CTFE]), a perfluoro-alkoxy fluororesin (PFA), and an ethylene tetrafluoroethylene copolymer (ETFE). The particle diameter of the fluororesin particles is 0.3 to 5 μm.

According to a second aspect of this invention, there is provided a method of producing a negative-chargeable erasable electrophotographic toner which includes mixing a binder resin, a near infrared absorption dye, a decolorizing agent, and a charge controlling agent, melt-kneading the mixture, and grinding the kneaded mass, wherein fluororesin particles are added in the mixing process, in the mixing process and the melt-kneading process, or in the melt-kneading process.

In the method of producing a negative-chargeable erasable electrophotographic toner according to the present invention, which is configured as described above, it is preferable to add 5 to 20 parts by mass of the fluororesin particles to 100 parts by mass of the binder resin. Further preferably, the fluororesin particles are selected from the group consisting of polytetrafluoroethylene (tetra-fluorinated resin [PTFE]), a polychlorotrifluoroethylene (tri-fluorinated resin [PCTFE, CTFE]), a perfluoro-alkoxy fluororesin (PFA), and an ethylene tetrafluoroethylene copolymer (ETFE). The particle diameter of the fluororesin particles is 0.3 to μm.

According to the present invention, there can be provided a negative-chargeable erasable electrophotographic toner having a sufficient negative-chargeable property and a method of producing the same.

### DETAILED DESCRIPTION OF THE INVENTION

Hereinafter, various embodiments of the present invention will be described.

In the negative-chargeable erasable electrophotographic toner according to an embodiment of the present invention, fluororesin particles are added in a process of mixing toner raw materials including a binder resin, a near infrared absorption dye, a decolorizing agent, and a charge controlling agent, or the mixing process and the melt-kneading process or the melt-kneading process.

If a print or image is formed by an electrophotographic process using such an erasable toner, the print or image is looked the color close to blue under visible light. However, if the print or image is irradiated with near infrared rays in a heated state, the print or image is decolorized. This is based on the following phenomenon.

That is, if the print or image is irradiated with near infrared rays in a state being heated at 80 to 160° C., the near infrared absorption dye in the toner becomes an excited state and reacts with the decolorizing agent. Thus, the decolorization phenomenon is caused. As a result, the print or image is decolorized and thus the paper can be reused.

For example, when the decolorizing agent is a quaternary ammonium boron anion, the decolorization is caused by bonding a dye cation of the near infrared absorption dye to an alkyl group of the quaternary ammonium boron anion.

In this case, the charge amount is decreased by an antistatic effect of the quaternary ammonium boron complex in itself as well as the interaction with the charge controlling agent. Thus, the image uniformity is impaired. However, occurrence of such a problem can be prevented by adding fluororesin particles.

As the near infrared absorption dye included in the erasable toner according to the present embodiment, a conventionally known one can be used. Examples of the near infrared absorption dye include those described in JP-A 4-362935 and JP-A 5-119520. Specific examples of the near infrared absorption dye include IRT™ (manufactured by Showa Denko K.K.).

As the decolorizing agent, a conventionally known one can be used. For example, a quaternary ammonium boron complex is used as the decolorizing agent.

Examples of the quaternary ammonium boron complex include those described in JP-A 4-362935 and JP-A 5-119520. Specific examples of the quaternary ammonium boron complex include P3B™ (manufactured by Showa Denko K.K.).

As the charge controlling agent, a conventionally known one can be used. Examples of the charge controlling agent include polymeric charge controlling agents and salicylic acid-based charge controlling agents. Examples of the polymeric charge controlling agents include Acrybase FCA of styrene acrylic-based polymer (trademark, manufactured by Fujikura Easel Co., a Ltd.). Examples of the salicylic acid-based charge controlling agents include Bontron™ (manufactured by Orient Chemical Industries Co., Ltd.).

The binder resin can be selected from a wide range including known binder resins. Specific examples thereof include styrene-based resins such as polystyrene, a styrene acrylic ester copolymer, a styrene methacrylic acid copolymer, and a styrene butadiene copolymer; a saturated polyester resin, an unsaturated polyester resin, an epoxy resin, a phenol resin, a cumarone resin, a xylene resin, a vinyl chloride resin, and a polyolefin resin. Two or more types of these resins may be combined for use. Among these resins, the polyester resin is preferred.

Examples of the fluororesin particle include polytetrafluoroethylene (tetra-fluorinated resin [PTFE]), a polychlorotrifluoroethylene (tri-fluorinated resin [PCTFE, CTFE]), polyvinylidene fluoride (PVDF), polyvinyl fluoride (PVF), a perfluoroalkoxy fluororesin (PFA), a tetrafluoroethylene hexafluoride propylene copolymer (FEP), an ethylene tetrafluoroethylene copolymer (ETFE), and an ethylenechlorotrifluoroethylene copolymer (ECTFE).

Among them, those selected from the group consisting of polytetrafluoroethylene (tetra-fluorinated resin [PTFE]), a polychlorotrifluoroethylene (tri-fluorinated resin [PCTFE, CTFE]), a perfluoroalkoxy fluororesin (PFA), and an ethylene-tetrafluoroethylene copolymer (ETFE) are preferred particularly in order to obtain a sufficient negative-chargeable toner.

Since the fluororesin particles have negative-chargeable properties, a good negative-chargeable toner can be obtained by adding the particles in the kneading process. As the fluororesin particles, polytetrafluoroethylene (tetra-fluorinated resin [PTFE]) is preferably used.

A process of adding a fluororesin as a standard toner is proposed in JP-A 2004-061816, JP-A 2004-061821, and JP-A 2005-195934. These proposals are intended to improve mold-release characteristics, water repellence, and rub resistance of normal toners. The present embodiment is related to a process of adding fluororesin particles to prevent positive-chargeable properties and adverse effects on decolorization reaction, which are specific characteristics of a near infrared erasable recording material which erases the color by absorbing and decomposing the near infrared absorption dye. Accordingly, it clearly differs in the subject being added and purpose of adding from the above-described proposals.

Further, the fluororesin functioning as a binder resin is disclosed in JP-A 7-325428. However, the technique described in JP-A 7-325428 relates to a process of mixing and melt-kneading two types of binder resins so as to have a sea island structure and it is configured that the fluororesin particles to be added are present as solid particles without melting or binding, have a high surface area, and exert highly chargeable properties. Accordingly, this technique differs in the purpose, function, and method for use from the present embodiment.

In the present embodiment, the addition amount of the fluororesin particles is preferably 20 parts by mass or less, more preferably 5 to 20 parts by mass based on 100 parts by mass of the binder resin.

It is desirable that the particle diameter of fluororesin particles is, for example, 0.3 to 5 μm. The particle diameter of fluororesin particles is preferably smaller than the toner particle diameter. The toner volume mean diameter (μm)/2 is desirably greater than the fluorine particle volume mean diameter (μm). When the particle diameter is too large, the chargeable properties may be reduced.

The negative-chargeable erasable electrophotographic toner according to one embodiment of the present invention may include a release agent in addition to the binder resin, near infrared absorption dye, decolorizing agent, charge controlling agent, and fluororesin particles. As the release agent, optional agents which are usually used for electrophotographic toners may be used.

According to another embodiment of the present invention, the negative-chargeable erasable electrophotographic toner can be produced by mixing a binder resin, a near infrared absorption dye, a decolorizing agent, a charge controlling agent, and fluororesin particles, melt-kneading of the mixture, and grinding the kneaded mass. In this regard, the fluororesin particles may be added not in the mixing process but in the melt-kneading process. The above-described mixing, melt-kneading, and grinding processes are usually used for the toner production process.

Hereinafter, Examples and Comparative Examples of the present invention will be described and the present invention will be more specifically explained.

### Example 1

100 parts by mass of a polyester resin (manufactured by Kao Corp., softening temperature: 110° C.) as a binder resin, 1.5 parts by mass of IRT (manufactured by Showa Denko K.K.) as a near infrared absorption dye, 3.5 parts by mass of P3B (manufactured by Showa Denko K.K.) as a decolorizing agent, 3 parts by mass of carnauba wax No. 1 powder (import product by S. Kato & Co.) as a release agent, 2 parts by mass of a salicylic acid-based charge controlling agent: Bontron E-84 (manufactured by Orient Chemical Industries Co., Ltd.) as a charge controlling agent, and Leblond L-2 (manufactured by Daikin industries, Ltd., the central diameter: 3 μm) fluororesin particles were well mixed by a Henschel mixer.

Then, the mixture was melt-kneaded by a biaxial extruder (trademark: PCM-43, manufactured by Ikegai Ltd.) to obtain a melt-kneaded mass. The obtained melt-kneaded mass was cooled and pulverized by a fluidized-bed counter let mill (200AFG, manufactured by Hosokawa Micron Ltd.). Thereafter, the fine particles were classified by a TSP toner separator (200TSP, manufactured by Hosokawa Micron Ltd.) and the colored particles having a weight average particle size of 9.0 μm were obtained.

Here, the toner particle diameter is a volume-average particle diameter value obtained by introducing a small amount of a sample, purified water, and a surfactant into a beaker, dispersing the sample with an ultrasonic cleaner, and measuring by MultiSizer II (manufactured by Coulter) (aperture: 100 μm, counting particles: 50,000).

1.5 parts by mass of an external additive: hydrophobic silica RX200 (manufactured by Nippon Aerosil Co., Ltd.) were added to 100 parts by mass of the colored particles thus obtained. The mixture was introduced into the Henschel mixer having a volume of 10 L and stirred at 3200 r/min for 180 seconds to obtain a toner.

### Examples 2 to 8

Toners were produced in the same manner as described in Example 1 except that the type of fluororesin particles, the central particle diameter, and the addition amount were variously changed as shown in Table 1 below.

### Examples 9 to 11

Since the particle diameter of the fluororesin used in Examples 9 to 11 was large, it was adjusted so as to have a central diameter of 4 μm using an air flow type pulverizer: Super Jet Mill SJ-500 (manufactured by, Nissin Engineering Inc.) and an elbow-jet classifier EJ-L-3 (Labo) type (manufactured by Matsubo Corporation). Toners were produced in the same manner as described in Examples 1 to 8 except that the fluororesin particles after adjusting the particle diameter were used.

The type, central diameter, and addition amount of fluororesin particles used in Examples 9 to 11 are shown in Table 1 below.

### Comparative Example 1

As shown in Table 1 below, a toner was produced in the same manner as described in Example 1 except that fluororesin particles were not added.

### Comparative Examples 2 and 3

As shown in Table 1 below, toners were produced in the same manner as described in Example 1 except that the type, central diameter, and addition amount of fluororesin particles were changed.

TABLE 1

| Kind | Characteristics | Manufacturer | Product name | Example 1 | Example 2 | Example 3 | Example 4 |
|---|---|---|---|---|---|---|---|
| Resin | Tm: 110° C. | Kao Corp. | Polyester resin | 100 | 100 | 100 | 100 |
| Release | Melting point: | S. Kato & Co. | Carnauba wax | 3 | 3 | 3 | 3 |
| agent | 83° C. | | No. 1 | | | | |
| Charge | Salicylic | Orient Chemical | E-84 | 2 | 2 | 2 | 2 |
| controlling | acid-based | Industries Co., | | | | | |
| agent | | Ltd. | | | | | |
| PTFE | Central. diameter: | Daikin Industries, | Leblond L-2 | 5 | 10 | | |
| particle | 3 μm | Ltd. | | | | | |
| | Central diameter: | Dalkin. Industries, | Leblond L-5 | | | 5 | |
| | 5 μm | Ltd. | | | | | |
| | Central diameter: | Seishin Enterprises | TEW-3000F | | | | 5 |
| | 3 μm | Co., Ltd. | | | | | |
| | Central diameter: | Kitamura Limited | KTL-500F | | | | |
| | 0.3 μm | | | | | | |
| | Central diameter: | Kitamura Limited | KTL-9s | | | | |
| | 6.2 μm | | | | | | |
| PCTFE | Central diameter: | Daikin Industries, | Neoflon M-400H | | | | |
| particle | 4 μm | Ltd. | | | | | |
| PEA | Central diameter: | Du Pont Co., Ltd. | Teflon PEA | | | | |
| particle | 4 μm | | 9738-J | | | | |
| ETFE | Central diameter: | Daikin Industries, | Neoflon EP-506 | | | | |
| particle | 4 μm | Ltd. | | | | | |
| Coloring | Near infrared | Showa Denko K.K. | IRT | 1.5 | 1.5 | 1.5 | 1.5 |
| agent | absorption dye | | | | | | |
| Decolorizing | Boron-based | Showa Denko K.K. | P3B | 3.5 | 3.5 | 3.5 | 3.5 |
| agent | compound | | | | | | |
| Kind | Characteristics | Manufacturer | Product name | Example 5 | Example 6 | Example 7 | Example 8 |
| Resin | Tm: 110° C. | Kao Corp. | Polyester resin | 100 | 100 | 100 | 100 |
| Release | Melting point: | S. Kato & CO. | Carnauba wax | 3 | 3 | 3 | 3 |
| agent | 83° C. | | No. 1 | | | | |
| Charge | Salicylic | Orient Chemical | E-84 | 2 | 2 | 2 | 2 |
| controlling | acid-based | Industries Co., | | | | | |
| agent | | Ltd. | | | | | |
| PTFE | Central diameter: | Daikin Industries, | Leblond L-2 | | | | |
| particle | 3 μm | Ltd. | | | | | |
| | Central diameter: | Daikin Industries, | Leblond L-5 | | | | |
| | 5 μm | Ltd. | | | | | |
| | Central diameter: | Seishin Enterprises | TEW-3000F | | | | |
| | 3 μm | Co., Ltd. | | | | | |
| | Central diameter: | Kitamura Limited | KTL-500F | 5 | 10 | 15 | 20 |
| | 0.3 μm | | | | | | |
| | Central diameter: | Kitamura Limited | KTL-9s | | | | |
| | 6.2 μm | | | | | | |
| PCTFE | Central diameter: | Daikin Industries, | Neoflon M-400H | | | | |
| particle | 4 μm | Ltd. | | | | | |
| PFA | Central diameter: | Du Pont Co., Ltd | Teflon PFA | | | | |
| particle | 4 μm | | 9738-J | | | | |
| ETFE | Central diameter: | Daikin Industries, | Neoflon EP-506 | | | | |
| particle | 4 μm | Ltd. | | | | | |
| Coloring | Near infrared | Showa Denko K.K. | IRT | 1.5 | 1.5 | 1.5 | 1.5 |
| agent | absorption dye | | | | | | |
| Deodorizing | Boron-based | Showa Denko K.K. | P3B | 3.5 | 3.5 | 3.5 | 3.5 |
| agent | compound | | | | | | |

| Kind | Characteristics | Manufacturer | Product name | Example 9 | Example 10 | Example 11 |
|---|---|---|---|---|---|---|
| Resin | Tm: 110° C. | Kao Corp. | Polyester resin | 100 | 100 | 100 |
| Release | Melting point: | Carnauba wax | No. 1 | 3 | 3 | 3 |
| agent | 83° C. | S. Kato & Co. | | | | |
| Charge | Salicylic | Orient Chemical | E-84 | 2 | 2 | 2 |
| controlling | acid-based | Industries Co., | | | | |
| agent | | Ltd. | | | | |
| PTFE | Central diameter: | Daikin Industries, | Leblond L-2 | | | |
| particle | 3 μm | Ltd. | | | | |
| | Central diameter: | Daikin Industries, | Leblond L-5 | | | |
| | 5 μm | Ltd. | | | | |
| | Central diameter: | Seishin Enterprises | TEW-3000F | | | |
| | 3 μm | Co., Ltd. | | | | |
| | Central diameter: | Kitamura Limfted | KTL-500F | | | |
| | 0.3 μm | | | | | |
| | Central diameter: | Kitamura Limited | KTL-9s | | | |
| | 6.2 μm | | | | | |
| PCTFE | Central diameter: | Daikin Industries, | Neoflon M-400H | 5 | | |
| particle | 4 μm | Ltd. | | | | |
| PFA | Central diameter: | Du Pont Co., Ltd | Teflon PEA | | 5 | |
| particle | 4 μm | | 9738-J | | | |
| ETFE | Central diameter: | Daikin Industries, | Neoflon EP-506 | | | 5 |
| particle | 4 μm | Ltd. | | | | |
| Coloring | Near infrared | Showa Denko K.K. | IRT | 1.5 | 1.5 | 1.5 |
| agent | absorption dye | | | | | |
| Decolorizing | Boron-based | Showa Denko K.K. | P3B | 3.5 | 3.5 | 3.5 |
| agent | compound | | | | | |
| | | | | Comparative | Cemparative | Comparative |
| Kind | Characteristics | Manufacturer | Product name | Example 1 | Example 2 | Example 3 |
| Resin | Tm: 110° C. | Kao Corp. | Polyester resin | 100 | 100 | 100 |
| Release | Melting point: | S. Kato & Co. | Carnauba wax | 3 | 3 | 3 |
| agent | 83° C. | | No. 1 | | | |
| Charge | Salicylic | Orient Chemical | E-84 | 2 | 2 | 2 |
| controlling | acid-based | Industries Co., | | | | |
| agent | | Ltd. | | | | |
| PTFE | Central diameter: | Daikin Industries, | Leblond L-2 | | | |
| particle | 3 μm | Ltd. | | | | |
| | Central diameter: | Daikin Industries, | Leblond L-5 | | | |
| | 5 μm | Ltd. | | | | |
| | Central diameter: | Seishin Enterprises | TEW-3000F | | | |
| | 3 μm | Co., Ltd. | | | | |
| | Central diameter: | Kitamura Limited | KTL-500F | | 25 | |
| | 0.3 μm | | | | | |
| | Central diameter: | Kitamura Limited | KTL-9s | | | 15 |
| | 6.2 μm | | | | | |
| PCTFE | Central diameter: | Daikin Industries, | Neoflon M-400H | | | |
| particle | 4 μm | Ltd. | | | | |
| PFA | Central diameter: | Du Pont Co., Ltd | Teflon PFA | | | |
| particle | 4 μm | | 9738-J | | | |
| ETFE | Central diameter: | Daikin Industries, | Neoflon EP-506 | | | |
| particle | 4 μm | Ltd. | | | | |
| Coloring | Near infrared | Showa. Denko K.K. | IRT | 1.5 | 1.5 | 1.5 |
| agent | absorption dye | | | | | |
| Decolorizing | Boron-based | Showa Denko K.K. | P3B | 3.5 | 3.5 | 3.5 |
| agent | corrpound | | | | | |

As for 14 kinds of toners thus obtained according to Examples 1 to 11 and Comparative Examples 1 to 3, the following characteristics were evaluated.

1. Blow-Off Charge Amount

0.3% by mass of each sample was added to iron powder carrier (Z-150/250) (manufactured by Powdertech), which was mixed with a turbular mixer for 20 minutes. The blow-off charge amount of the samples was measured using a blow-off powder charge amount analyzer having a SUS wire gauze having 400 meshes (manufactured by Toshiba Chemical Corp.) under the conditions of blow pressure of 1 kgf/cm² for 60 seconds in a laboratory where the temperature was adjusted to 23±3° C. and the humidity was adjusted to 50±15%.

2. Photoconductor (OPC) Fogging Value

A toner was installed in a non-magnetic single component developing device (Casio Page Presto N3600, manufactured by Casio Computer Co., Ltd.: color printer, at a speed of 24 pages per minute (A4 size, horizontal type). In a normal environment (25° C., 50% RH), 5% of printing image was continuously printed on 10,000 pages of regular paper (A4-size Xerox-P paper). Then, printing was performed on white-paper and the printing was forcedly stopped by opening the front door during printing operation. At that time, the fogging toner on the OPC drum was transferred to a mending tape and the tape was stuck to white paper. Then, the paper was compared with a tape to which the fogging toner was not transferred.

In the measurement, as the fogging value, the maximum value of the differences before and after fogging was calculated from X, Y, and Z values obtained by using an SE-2000 spectroscopic colorimeter (manufactured by Nippon Denshoku Industries Co., Ltd.). The fogging value was evaluated by the following criteria:

⊚: the fogging value is less than 2;

◯: the fogging value is 2 or higher and less than 5;

Δ: the fogging value is 5 or higher and less than 10, at a level with practically no problem; and

X: the fogging value is 10 or higher.

3. White-Paper Fogging Test Value

An erasable toner was installed in a K cartridge position of a non-magnetic single component developing device (Casio Page Presto N3600, manufactured by Casio Computer Co., Ltd.: color printer, at a speed of 24 pages per minute (A4 size, horizontal type). In a usual environment (25° C., 50% RH), the white paper was printed in a monochrome mode. The whiteness degree of the paper before and after printing was measured by using the SC-2000 spectroscopic colorimeter. As the fogging value, the maximum value of the differences before and after fogging was calculated from the obtained X, Y, and Z values, and the value was evaluated as follows:

⊚: the fogging value is less than 2;

◯: the fogging value is 2 or higher and less than 5;

Δ: the fogging value is 5 or higher and less than 10, at a level with practically no problem; and

X: the fogging value is 10 or higher.

4. Visibility

The obtained image samples were measured by X-rite938 (manufactured by X-rite). The measured items were color systems L*, a*, and b* based on the uniform color spaces of the printed portion and the non-printed portion. As for decolorization characteristics, a color difference between the printed portion after decolorization and the non-printed portion (hereinafter indicated as color difference between the printed portion after decolorization—the non-printed portion) was calculated based on Equation 1 below using the above measured items.

Color difference ΔE={(L* of the printed portion of−L* of the non-printed portion)²+(a* of the printed portion−a* of the non-printed portion)²+(b* of the printed portion−b* of the non-printed portion)²}^{1/2} (Equation 1)

The color difference was evaluated by the following criteria: As the value of the color difference between the printed portion after decolorization and the non-printed portion is lower, the color of the printed portion after decolorization is close to that of the basic paper and the degree of decolorization is high.

◯: the color difference is 0 or higher and less than 3;

Δ: the color difference is 3 or higher and less than 5; and

X: the color difference is 5 or higher

The test results are shown in Table 2 below.

TABLE 2

| | Example | Example | Example | Example | Example | Example | Example |
|---|---|---|---|---|---|---|---|
| Evaluation items | 1 | 2 | 3 | 4 | 5 | 6 | 7 |
| Blow-off charge | 30 | 45 | 32 | 34 | 33 | 48 | 50 |
| amount (−μC/g) | | | | | | | |
| OPC fogging | ◯ | ⊚ | Δ | ◯ | ⊚ | ⊚ | ⊚ |
| value (ΔZ value) | | | | | | | |
| White-paper fogging | ⊚ | ⊚ | ◯ | ◯ | ⊚ | ⊚ | ⊚ |
| value (ΔZ value) | | | | | | | |
| Visibility (ΔE) | ◯ | Δ | Δ | ◯ | ◯ | ◯ | ◯ |
| | Example | Example | Example | Example | Comparative | Comparative | Comparative |
| Evaluation items | 8 | 9 | 10 | 11 | Example 1 | Example 2 | Example 3 |
| Blow-off charge | 55 | 34 | 42 | 40 | 15 | 58 | 46 |
| amount (−μC/g) | | | | | | | |
| OPC fogging | ⊚ | ◯ | ◯ | ◯ | X | ⊚ | ⊚ |
| value (ΔZ value) | | | | | | | |
| White-paper fogging | ⊚ | ◯ | ◯ | ◯ | X | ⊚ | ⊚ |
| value (ΔZ value) | | | | | | | |
| Visibility (ΔE) | Δ | ◯ | ◯ | ◯ | ◯ | X | X |

The following facts are found from Table 2 above.

In the toners according to Examples 1 to 11 in which fluororesin particles were added to the toner raw material, a blow-off charge amount was increased and the negative-chargeable properties were improved. The fogging performance of the photoconductor (OPC) and the white paper was improved by the improvement in the negative-chargeable properties.

In contrast, the blow-off charge amount of the toner of Comparative Example 1 was low and the fogging performance of the OPC and the white paper was not good.

It is found that the charged properties are dependent on the addition amount and the particle diameter of fluororesin particles, and the negative-chargeable properties become higher as the particle diameter is smaller and the addition amount is larger.

In contrast, in the toner of Comparative Example 2, the particle diameter is small, the negative-chargeable properties are high, similarly to Examples 5 to 8. However, the toner is inferior in visibility because the addition amount is too large by 25 parts by mass.

In the toner of Comparative Example 3, the addition amount is 15 parts by mass, similarly to Example 7, however the toner is inferior in visibility similarly to Comparative Example 2 because the particle diameter is too large.

From these results, it is considered that the addition amount of the fluororesin particles is preferably from 5 to 20 parts by mass based on 100 parts by mass of the binder resin and the particle diameter of the fluororesin particles is preferably from 0.3 to 5 μm.

What is claimed is:

1. A negative-chargeable erasable electrophotographic toner comprising:
a binder resin;
a near infrared absorption dye;
a decolorizing agent;
a charge controlling agent; and
fluororesin particles.

2. The negative-chargeable erasable electrophotographic toner according to claim 1,
wherein the toner is obtained by adding 5 to 20 parts by mass of the fluororesin particles to 100 parts by mass of the binder resin.

3. The negative-chargeable erasable electrophotographic toner according to claim 1,
wherein the fluororesin particles are selected from the group consisting of polytetrafluoroethylene, a polychlorotrifluoroethylene, a perfluoro-alkoxy fluororesin, and an ethylene tetrafluoroethylene copolymer.

4. The negative-chargeable erasable electrophotographic toner according to claim 1,
wherein the particle diameter of the fluororesin particles is 0.3 to 5 μm.

5. The negative-chargeable erasable electrophotographic toner according to claim 2,
wherein the fluororesin particles are selected from the group consisting of polytetrafluoroethylene, a polychlorotrifluoroethylene, a perfluoro-alkoxy fluororesin, and an ethylene tetrafluoroethylene copolymer.

6. The negative-chargeable erasable electrophotographic toner according to claim 3,
wherein the particle diameter of the fluororesin particles is 0.3 to 5 μm.

7. The negative-chargeable erasable electrophotographic toner according to claim 5,
wherein the particle diameter of the fluororesin particles is 0.3 to 5 μm.

8. A method of producing a negative-chargeable erasable electrophotographic toner, comprising:
mixing a binder resin, a near infrared absorption dye, a deodorizing agent, and a charge controlling agent;
melt-kneading the mixture; and
grinding the kneaded mass;
wherein fluororesin particles are added in the mixing process, in the mixing process and the melt-kneading process or in the melt-kneading process.

9. The method according to claim 8,
wherein 5 to 20 parts by mass of the fluororesin particles are added to 100 parts by mass of the binder resin.

10. The method according to claim 8,
wherein the fluororesin particles are selected from the group consisting of polytetrafluoroethylene, a polychlorotrifluoroethylene, a perfluoro-alkoxy fluororesin, and an ethylene tetrafluoroethylene copolymer.

11. The method according to claim 8,
wherein the particle diameter of the fluororesin particles is 0.3 to 5 μm.

12. The method according to claim 9,
wherein the fluororesin particles are selected from the group consisting of polytetrafluoroethylene, a polychlorotrifluoroethylene, a perfluoro-alkoxy fluororesin, and an ethylene tetrafluoroethylene copolymer.

13. The method according to claim 10,
wherein the particle diameter of the fluororesin particles is 0.3 to 5 μm.

14. The method according to claim 12,
wherein the particle diameter of the fluororesin particles is 0.3 to 5 μm.
